(19) United States
(12) Patent Application Publication
(10) Pub. No.: US 2002/0073627 A1
(43) Pub. Date: Jun. 20, 2002

(54) Lightweight door for motor vehicles

(76) Inventor: Michael Hock, Grobestheim (DE)

Correspondence Address: Michael E. Taken, ANDRUS, SCEALES, STARKE & SAWALL, LLP, Suite 1100, 100 East Wisconsin Avenue, Milwaukee, WI, 53202-4178, US

(21) Appl. No.: 10/024,746

(22) Filed: Dec. 19, 2001

(30) Foreign Application Priority Data
Dec. 19, 2000 (DE) 100 63 417.6

(51) Int. Cl. B60J 5/04

(52) U.S. Cl. 49/502; 296/146.5

(57) ABSTRACT

The present invention relates to a lightweight door for motor vehicles, using the hidden bar-element construction technique. It is characterised by the supporting frame being made in a single piece from a metal sheet of minimum thickness; said metal sheet being a pressed part or a deepdrawn part.

The invention relates to the structure of a lightweight door for motor vehicles, i.e. a body-in-white door which, after the painting process, will be completed with further installed components such as window lifts, interior door panels etc.

The design of doors for motor vehicles is determined by various requirements. These include e.g. static rigidity requirements, dynamic rigidity requirements as well as requirements concerning installation space and the arrangement of installed components. Static rigidity requirements include for example requirements relating to bending and torsion of the window frame, and requirements relating to sagging and application of excessive pressure on the door overall. Dynamic rigidity requirements arise from safety requirements during head-on and side-on crashes and from further requirements concerning passenger protection. Space requirements relate to practicable installation and operation of bolt-on and functional parts in or on the door; maintaining clearance spaces for installation work; maintaining minimum clearances to movable components; maintaining spaces between parallel areas, in particular for sealing purposes; separating the interior space of the door into dry areas and wet areas, etc.

In principle, the above-mentioned requirements for motor vehicle doors apply irrespective as to the particular design type of a motor vehicle door.

Up to now, steel sheet has been the most widely used raw material for motor vehicle doors. The conventional technique of a fully pressed door in shell technology is known. Such a door comprises two pressed shells which are interconnected and also connected to a glass channel frame. Later on, components are installed on the inner shell.

The frame door represents a further conventional door concept. The frame door comprises a window frame made from steel, said window frame comprising a rolled profile bent by stretching and rolling, which window frame is welded or screwed to a door box. The door box in turn comprises two pressed steel shells which are interconnected.

From the point of view of forming variants, a frame door comprising a window frame welded in the door box is substantially more advantageous. Such a steel door for motor vehicles is for example known from EP 0 476 351 A1. With this design type, many identical components can be used for different vehicle types.

It has been shown that the previously explained modular system door can also be produced from light metal/light metal alloys, in particular from aluminium alloys. A respective example, which represents the nearest state of the art, has been described in DE 196 16 788 A1. The lightweight door for motor vehicles described in the above mentioned patent specification comprises an outer skin of the door and a supporting frame, with the supporting frame comprising a hinge support forming one U-limb, a lock support forming the other U-limb, and a door bottom forming the U-stay. The hinge support and the lock support are cast parts made from a light metal alloy, in particular from an aluminium alloy, while the door bottom which connects them is an extruded profile, pressed profile or rolled profile made from a light metal alloy, in particular from an aluminium alloy. The components are interconnected by means of rivet connections and bonding. The supporting frame is closed off at the open top of the U by outer and inner window gutter profiles which can also be extruded aluminium profiles. Window channel profiles and hinge reinforcements complete the frame structure of this lightweight door. Designing the hinge support and the lock support as light metal cast parts makes it possible to achieve complex shapes, but is expensive.

It is thus the object of the invention, from the point of view of design, to optimise the previously explained lightweight door for motor vehicles—said door using predominantly parts made from light metal/light metal alloys—taking into account the particular characteristics of light metal, in particular of aluminium.

The quite different materials properties of steel and light metal, in of particular aluminium, are to be taken into account. The yield point of steel used for vehicle construction is usually higher than that of corresponding rolled sheet made from aluminium. Very complex and diversified aluminium extruded profiles of very high dimensional quality are available comparatively economically. By contrast, complex steel profiles are difficult to produce, which is reflected in their high cost, and they are difficult to vary. Due to the physical properties of aluminium rolled sheet, its formability as a result of deep drawing, stamping or bending is inferior to that of steel sheet. As a result, aluminium sheet is associated with larger radii and smaller degrees of clearance during constructional shaping of the parts. The same applies to other light metals and light metal alloys, in particular also to magnesium.

The above mentioned boundary conditions make it impossible to transfer design concepts for steel doors for vehicles, directly to light metal doors. Instead, other ways must be found.

The lightweight door for motor vehicles, according to the invention, meets the above-mentioned objective with the characteristics of claim 1. It is essential that the invention provides a design which altogether has been realised with the particular characteristics of light metal, in particular of aluminium, in mind. The realised structure uses a type of hidden bar element construction. Closed chamber profiles are used for load paths of impinging forces and moments. The individual bars of the bar work construction join to form structural frame gussets where they are welded together. This results in a torsionally rigid frame structure. More heavily loaded areas which cannot be optimally supported using the bar-element construction technique, in particular areas around hinges and the lock, are specifically reinforced. By contrast, the large areas of the lightweight door where forces and moments impinge only to a small extent, can be made with thin walls as pressed parts or deep drawn parts made from light metal sheet, in particular from aluminium sheet. This results in considerably reduced weight of the lightweight door, without there being a negative effect on rigidity.

Further preferred embodiments and improvements of the basic teaching of the invention are provided in the subordinate claims.

Below, the invention is explained in more detail by means of a drawing which shows examples of embodiments, as follows:

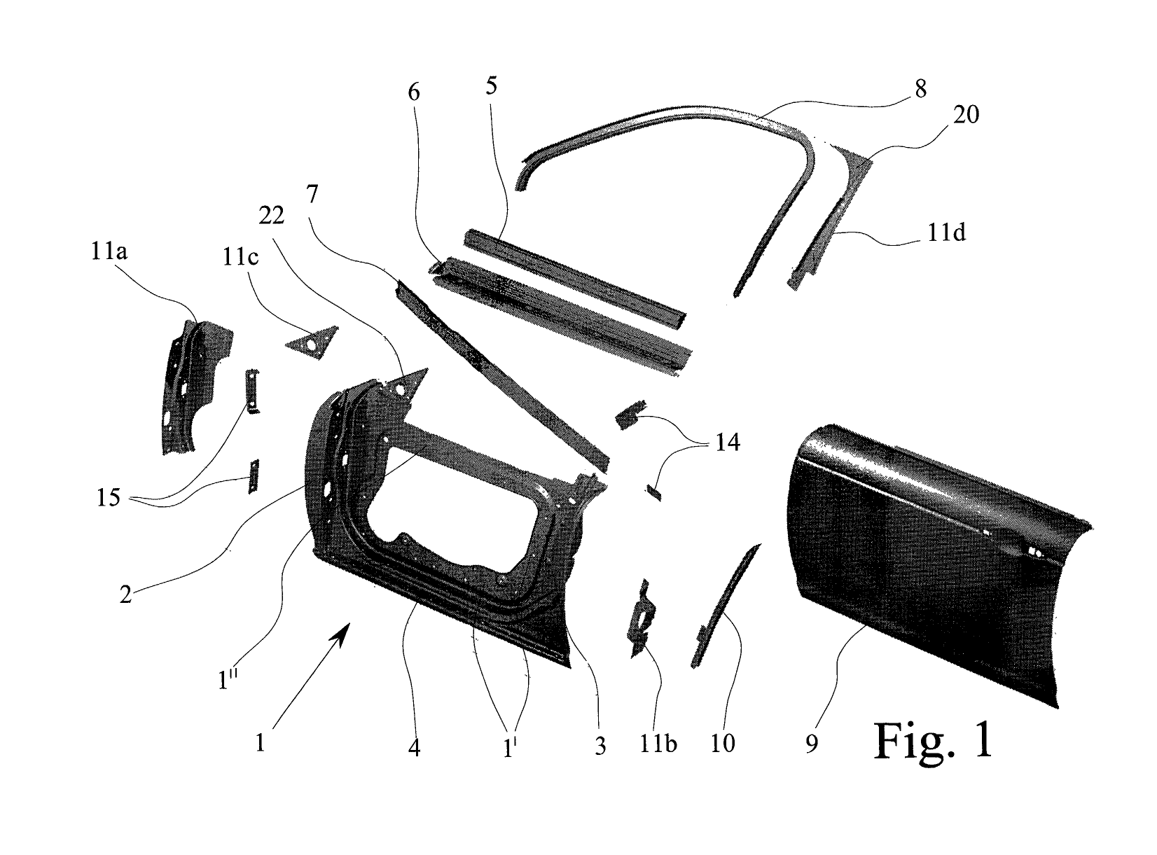

FIG. 1 an exploded view of a light metal door according to the invention-front side door;

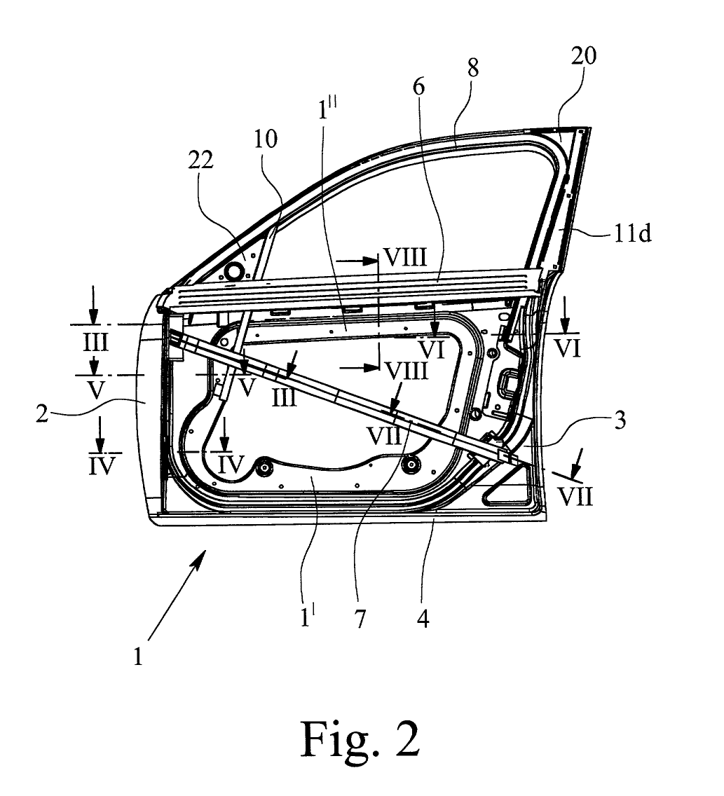

FIG. 2 a view of the supporting frame with window frame of the vehicle door shown in FIG. 1, showing the sections of the following figures;

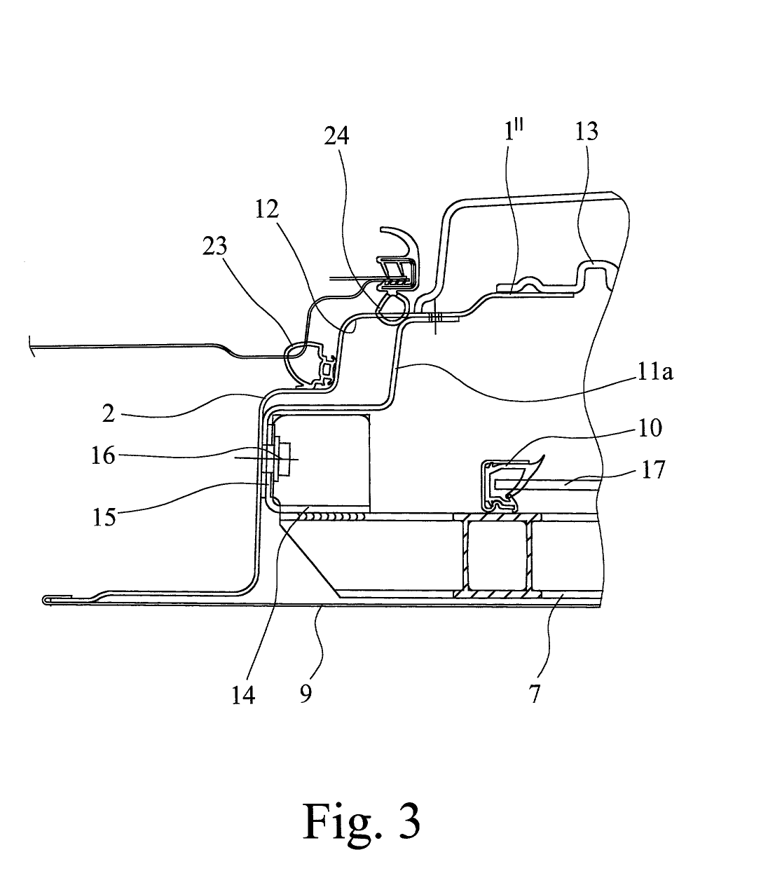

FIG. 3 a section III-III shown in FIG. 2;

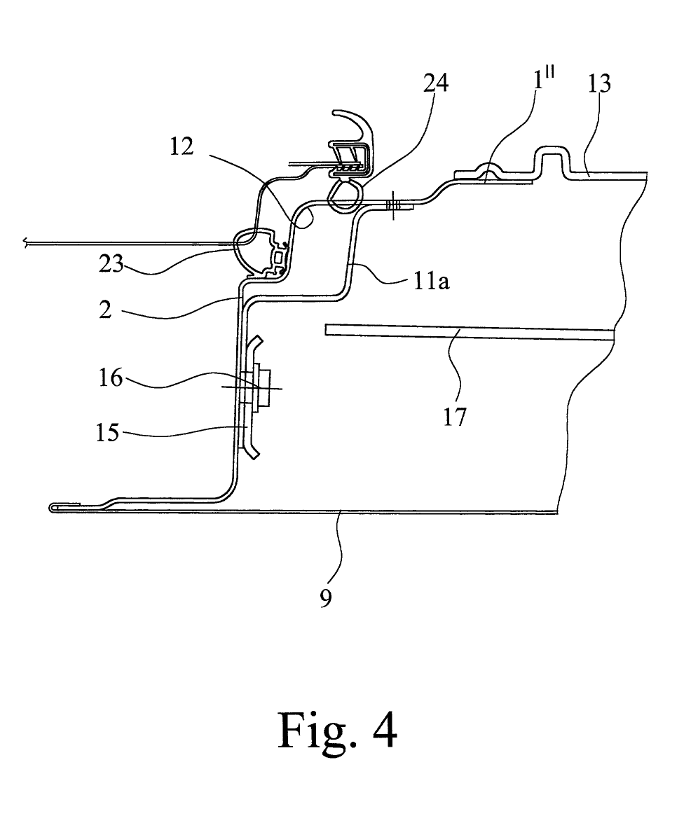

FIG. 4 a section IV-IV shown in FIG. 2;

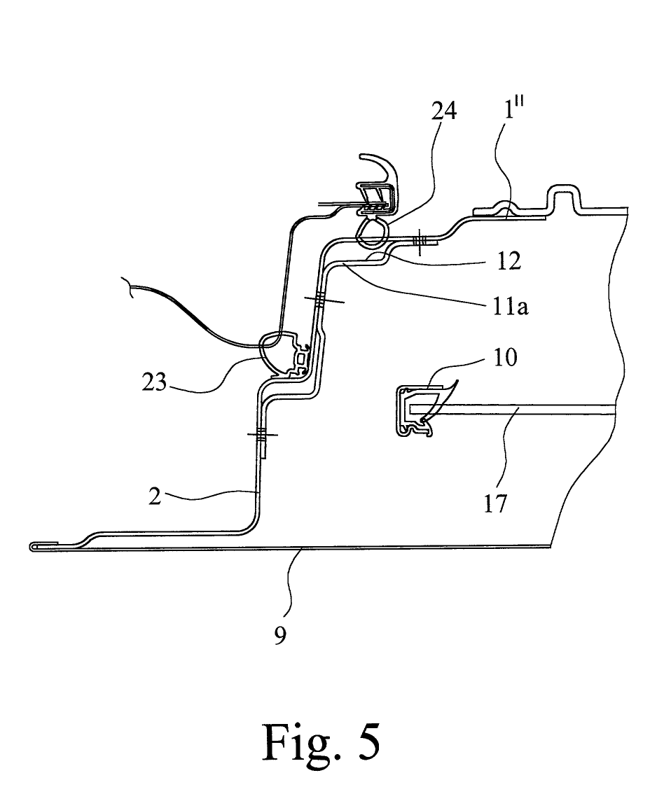

FIG. 5 a section V-V shown in FIG. 2;

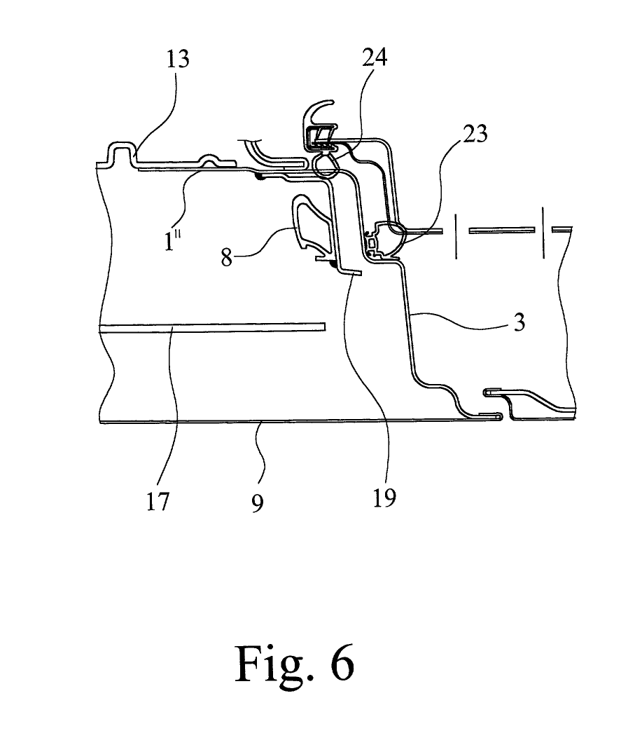

FIG. 6 a section VI-VI shown in FIG. 2;

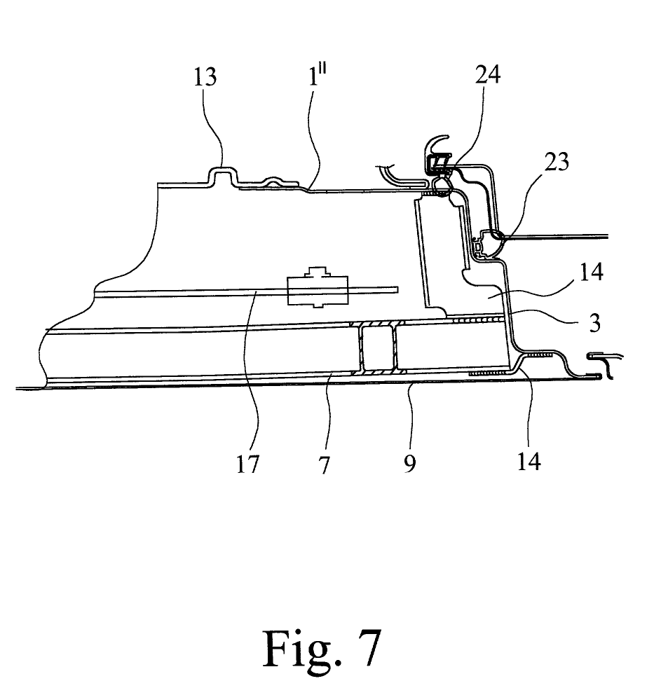

FIG. 7 a section VII-VII shown in FIG. 2; and

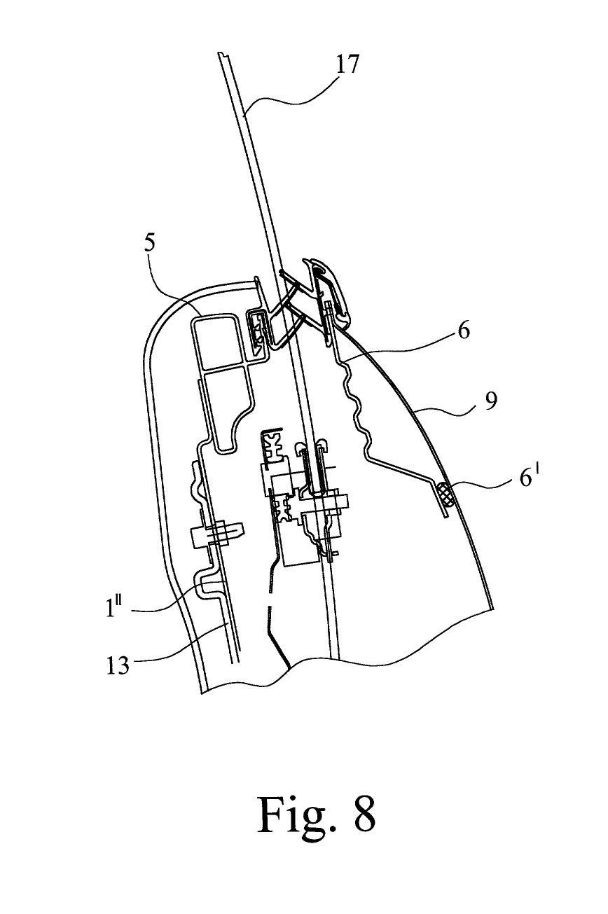

FIG. 8 a section VIII-VIII shown in FIG. 2.

In the context of the following explanations of the invention, the figures of the drawing should be consulted. FIG. 1 of the drawing explains the principle of the invention by means of a front side door. Correspondingly, the principle can also be transferred to a rear side door, if necessary also to a rear gate or tailgate.

The figures show a lightweight door for motor vehicles, comprising an essentially U-shaped supporting frame 1, with said supporting frame 1 comprising: a hinge support 2 forming one U-limb, a lock support 3 forming the other U-limb and a door bottom 4 forming the U-stay. Further provided are an inner and outer window gutter profile 5, 6, supplementing the U-shaped supporting frame 1, said window gutter profiles being made from light metal/light metal alloys, in particular from aluminium/aluminium alloys.

In a lightweight door installed in a motor vehicle body, the window gutter profiles 5, 6 are essentially aligned in longitudinal direction of the vehicle. Their ends are permanently connected, in particular welded, to the hinge support 2 and the lock support 3 respectively, of the supporting frame 1. In particular MIG shielded arc welding or laser welding with corresponding applications, is recommended for welding light metal, particularly aluminium.

Furthermore a lateral impact protection element 7, arranged in the supporting frame 1, is provided. According to the preferred teaching, said lateral impact protection element 7 is arranged diagonally in the supporting frame 1, as shown in the embodiment. The lateral impact protection element 7 is an extruded profile made from light metal/light metal alloys, in particular from aluminium/aluminium alloys, and at its ends is permanently connected to, in particular welded to, the supporting frame 1.

Furthermore, a profile window frame 8 made in one piece from light metal/light metal alloys, in particular from aluminium/aluminium alloys, forms part of the lightweight door according to the invention. At its ends, said profile window frame 8 is permanently connected, in particular welded, in any case to the inner window gutter profile 5. Also part of the lightweight door is an outer skin 9 of the door, said outer skin 9 being made in one piece and being permanently connected to the supporting frame 1 and the outer window gutter profile 6, in the present case in particular by flanging. Preferably, the window frame 8 is an extruded profile, bent by stretching and rolling. Its particular design is the subject of a parallel patent application (U.S. Ser. No. ______) whose content by reference also forms part of the present disclosure.

FIG. 1 of the drawing shows the lightweight door with the supporting frame 1 made in one piece from a light metal/light metal alloy sheet of minimum thickness, in particular made from aluminium/aluminium alloys, in particular from a rolled aluminium sheet. The supporting frame 1 is a pressed part or a deep-drawn part. In the case of aluminium or an aluminium alloy, the thickness of the sheet is approx. 1.2 to 1.8 mm, in particular approx. 1.6 mm.

The embodiment shown, which is the preferred embodiment, with the supporting frame 1 made in one piece as a pressed part or deep-drawn part made from rolled aluminium sheet, is further characterised in that an area of the inside skin 1′ of the door forms part thereof. In the embodiment shown, which is the preferred embodiment, this results in the supporting frame 1 furthermore forming an area-shaped cross stay 1″ which closes the basic U-shape and which is located opposite the door bottom 4. In other words, the cross stay 1″ closes the supporting frame 1 at the free ends of the U-limbs, so as to form an O, thus significantly increasing and optimising torsional rigidity.

When in the course of the description it is stated that elements are connected to the hinge support 2 and the lock support 3 of the supporting frame 1, when the cross stay 1″ is realised, this statement is supplemented to the effect that these parts can be, or are, connected directly to the cross stay 1′, if necessary also in addition. This applies in particular to the inner window gutter profile 5 which can be connected directly to the cross stay 1.

The above explanation in conjunction with the representation in FIG. 1 explains the complete structure of the lightweight door made from light metal, in particular from aluminium or an aluminium alloy, in the form of a bar element construction.

As has been explained above, in the design according to the invention, the load paths from forces and moments impinging on the structure, as far as possible are concentrated on the bars of the bar element. In order to introduce the forces into the frame structure, preferably the design according to the invention ensures local coincidence of the connection regions of the various structural members, namely supporting frame 1, inner window gutter profile 5, lateral impact protection element 7 and window frame 8, so as to form structural frame gussets. Below, this is described in more detail by means of individual examples. FIGS. 1 and 2 show a window channel 10.

Furthermore, the design provides for reinforcement and connection sheets 11 to be arranged on the supporting frame 1 in more heavily loaded areas, in particular in the region of structural frame gussets. Said reinforcement and connection sheets 11 are connected to the supporting frame 1 by press-riveting, bonding and/or, in particular, welding. In this way, the necessary reinforcement in the large areas of the lightweight door is achieved with the smallest possible thickness of the light metal sheet. It is envisaged that the reinforcement and connection sheets 11, too, are pressed parts or deep-drawn parts made from light metal/light metal alloys, in particular from aluminium/aluminium alloys.

By way of reinforcement and connection sheets 11 made from aluminium alloys, the embodiment shown first shows a hinge reinforcement 11a, then a lock reinforcement 11b, a mirror triangle 11c and a frame reinforcement part 11d, all of which are pressed parts or deep-drawn parts made from light metal, in particular from aluminium or an aluminium alloy.

As indicated in FIGS. 1 and 2, and shown in more detail in FIGS. 3, 4 and 5, the reinforcement and connection sheet 11—hinge reinforcement 11a—in part with the support frame 1, in this case the hinge support 2, forms hollow chambers 12. In FIG. 5, between the hinges, the hinge reinforcement 11a rests essentially flush against the surface of the hinge support 2. In FIGS. 3 and 4, these two components form a hollow chamber 12. On the rim side, these two components are interconnected by press-riveting, welding and/or bonding. By forming the hollow chamber 12, structural reinforcement is achieved because so far a box-section profile has been realised, at least in some sections.

Concerning the flow of force during a head-on collision, introduction and propagation of force by means of the inner window gutter profile 5 assumes particular significance. The cross-section of the inner window gutter profile 5 should be designed so as to prevent, as far as possible, a collapse transversely to the longitudinal axis. To this effect, the invention provides for the inner window gutter profile 5 to be a box-section extrusion profile; preferably a multi-chamber profile with at least two chambers separated by stays. The invention provides for the inner window gutter profile 5 to be designed and arranged so as to be perfectly straight. Such an arrangement supports the introduction of force such that forces acting in longitudinal direction can be propagated along the passenger compartment without any offset. In this way, during a head-on collision, the inner window gutter profile 5 transmits up to 80 % of the forces acting in longitudinal direction. The lateral impact protection element 7 accounts for up to approx. 20 % of the forces acting in longitudinal direction, depending on the incidence and attachment. The solution of attaching the ends of the lateral impact protection element 7, necessary for this, will be explained in more detail later.

In the embodiment shown, the inner window gutter profile 5 has however a further function. As is shown in a section view of this area in FIG. 8, said inner window gutter profile comprises an additional flange extending in longitudinal direction, which flange in the present example carries the inner window gutter seal. Such a design of the window gutter profile 5 has already been proposed (DE 199 29 872 A1). The characteristics of designing a flange on the window gutter profile, as shown in said patent specification, can be realised irrespective of the production technique and the material, and they can be applied in the case of the present embodiment too. In particular the design as a box-section extrusion profile made from aluminium, provides flexible options for designing such flanges.

Furthermore, FIG. 8 shows the attachment of the window gutter profile 5 to the cross stay 1″ of the supporting frame 1. This cross stay 1″ at the same time constitutes the attachment options for an interior door module 13 which will be inserted later; said module being merely indicated in FIG. 8.

As far as the design of the outer window gutter profile 6 is concerned, it is preferably a pressed part or a deep-drawn part, of course also made from light metal/light metal alloys, in particular from aluminium/aluminium alloys. According to a preferred teaching, it also comprises additional flanges extending in longitudinal direction (FIG. 8). One of the flanges comprises an adhesive bead 61 for adhesive fastening of the outer skin 9 of the door.

Previously it has been pointed out that the lateral impact protection element 7 assumes a considerable function not only during a lateral impact but also during a head-on crash, in that up to 20% of the forces acting in longitudinal direction are transmitted via the lateral impact protection element 7.

To attach the lateral impact protection element 7 in the supporting frame 1, the side door shown provides for the ends of the lateral impact protection element 7 to be attached, in particular welded, to the supporting frame 1 using brackets 14. FIG. 3 shows the attachment of the lateral impact protection element 7 shown top left in FIG. 2; FIG. 7 shows the attachment of the lateral impact protection element 7 shown bottom right in FIG. 2. The brackets 14 are shown. Two weld seems, extending longitudinally to the lateral impact protection element 7, fix said lateral impact protection element 7 to the brackets 14 which in turn are welded to the supporting frame 1. Below, this will be explained in somewhat more detail.

The embodiment of a front side door, shown in FIG. 1, at the hinge support 2 shows upper and lower hinge point strengthening plates 15 which are also made from light metal/light metal alloys, in particular from aluminium or an aluminium alloy. These are in particular attached by point welding at these positions. They absorb the significant forces which at these locations have to be introduced to the supporting frame 1 which is made in one piece. FIGS. 3 and 4 show the arrangement of the hinge point strengthening plate 15 of this embodiment, with galvanically coated steel nuts 16 already pressed in, said steel nuts 16 being used to anchor connecting screws.

The embodiment shown provides for the lateral impact protection element 7 on a front side door to be arranged so as to slope downward from the hinge support 2 to the lock support 3, or so as to be horizontal, and for the free L-limb of the upper hinge point strengthening plate 15 to be L-shaped and directly welded together with the end of the lateral impact protection element 7 situated in this location (FIG. 3). Thus the free L-limb of the hinge point strengthening plate 15 constitutes the bracket 14.

By contrast, in the case of a rear side door, where the lateral impact protection element 7 is upward sloping or horizontal from the hinge support 2 to the lock support 3, the lower hinge point strengthening plate 15 would be L-shaped and its free L-limb would be directly welded to the end of the lateral impact protection element 7 situated in this location.

Furthermore, FIGS. 3 and 5 show the window channel profile 10 and the window glass 17.

Prior to point welding the hinge point strengthening plates 15 to the hinge reinforcement 11a, the air gap between the bearing surfaces of said hinge point strengthening plates 15 and said large-area hinge reinforcement 11a which forms the hollow chambers 12, is filled in over the entire area, preferably using a special adhesive, so that the components are also bonded together.

Overall, rigidity of the lightweight door is significantly increased in that the window frame 8 is rigidly connected, in a highly effective way, to the supporting frame 1. To this effect, the embodiment shown, which is the preferred embodiment, provides for the ends of the window frame 8 to extend beyond the front and rear end of the inner window gutter profile 5, where they are welded to the window gutter profile 5. As a result, the window frame 8 reaches comparatively far down into the door gutter region. This provides an adequate lever arm to effectively deflect bending moments impinging from the outside, into the door frame 1. At the hinge reinforcement 11b, the embodiment shown (FIG. 6) comprises an additional frame shoulder 19 which is welded to the end of the window frame 8 which end is located in this location. FIG. 6 shows that the window frame 8 extends quite deeply into the door gutter region. The position of this section is shown in FIG. 2. In this way, the point of application of the forces is brought close to the lock position.

As has been mentioned above, according to the invention, the metal sheet in the large-area elements of the lightweight door is thin, but in certain areas reinforcement and connection sheets 11 are added and attached.

In this respect, FIG. 1 also shows that the window frame 8, on the side facing the lock support 3, is reinforced by an elongated frame reinforcement part 11d. This is a pressed part or deep-drawn part made from thin-walled metal sheet (light metal, light metal alloy, in particular aluminium, aluminium alloy). In this case, as in most cases, welding is the connection technique used. The embodiment shown further provides for the frame reinforcement part lid also to be connected to the outer window gutter profile 6 by way of welding.

The embodiment of a front side door shown in FIG. 1 also shows that an upper angular section 20 of the window frame 8 is integrated in the frame reinforcement part lid shown in this location. In the case of a rear side door, for example a cover could be integrated which covers part of the B-pillar.

In the context, FIGS. 1 and 2 show that in this position on the supporting frame 1, namely in the extension of the upper hinge support 2 above the window gutter profile 6, a mirror triangle 22 is formed. A further mirror triangle 11c, located on the outside, partially reinforces the attachment gusset of a mirror. Said mirror triangle 11c is connected to the window frame 8, preferably by welding.

FIGS. 1 and 2 further show that the window frame 8 leads past the mirror triangle 22/11c and enters a respective acceptance at the hinge support 2 or at the hinge reinforcement 11a on the supporting frame 1, where it is welded. FIG. 1 indicates the relative position of the components involved, so that the desired frontal welding of the window frame 8 to the inner window gutter profile 5 and to the supporting frame 1, in particular to its hinge support 2, can take place.

A surrounding main seal 23, shown in FIGS. 3 to 7, is arranged all around. A further surrounding seal 24 can be arranged on the side of the bodywork, thus acting together with the inner seal bearing surfaces. In the drawing, the seals 23, 24 are shown in the relaxed position; they will of course subsequently be compressed to the dimension of the gap.

In the concept according to the invention, the weld seams of the weld connections are preferably L-shaped seams so as to increase rigidity and prevent a hinge effect. This applies above all to the weld seams of the hidden bar element construction which carries the main load.

Finally, in the case of a lightweight door according to the invention, either a pressed outer skin 9 of the door, made from sheet metal, or an outer skin 9 of the door, made from plastic, can be attached. Thus, as is the case in the embodiment shown, the outer skin 9 of the door can be made from a drawn part, for example aluminium sheet with a thickness of approx. 1.0 mm, being connected to the supporting frame 1 and the outer window gutter profile 6 by flanging and bonding.

The plastic alternative consists of the outer skin 9 of the door being connected to the supporting frame 1 and the outer window gutter profile 6 by pushing on/locking on of tongue and groove connections and/or by clip connections. In this context we refer to the state of the art in general, which shows a multitude of alternatives.

It is not absolutely necessary for the window frame 8 of the lightweight door to be made in a single piece; if necessary it can also be made from two connected extruded profiles. This solution would for example suggest itself in those cases where a sharp angle in the window region is desired. Said angle can then be realised by means of mitre cuts and welding together the extruded profiles.

1. A lightweight door for motor vehicles
comprising an essentially U-shaped supporting frame (1) made from light metal or a light metal alloy, wherein said supporting frame (1) comprises: a hinge support (2) forming one U-limb, a lock support (3) forming the other U-limb and a door bottom (4) forming the U-stay, with an inner and an outer window gutter profile (5, 6) which is made from light metal or a light metal alloy, said window gutter profile (5, 6) supplementing the U-shaped supporting frame (1);
wherein if the lightweight door is installed in a motor vehicle body, the window gutter profiles (5, 6) are essentially aligned in longitudinal direction of the vehicle, with the ends of the window gutter profiles (5, 6) being permanently connected to the hinge support (2) and the lock support (3);
comprising a lateral impact protection element (7) arranged in the supporting frame (1), with the ends of said impact protection element (7) being permanently connected to the supporting frame (1), wherein the lateral impact protection element (7) is an extruded profile made from light metal or a light metal alloy;
comprising a window frame (8) made from light metal or a light metal alloy, wherein the ends of the window frame (8) in any case are permanently connected to the inner window gutter profile (5);
wherein the supporting frame (1) is made in one piece as a pressed part or a deep-drawn part, from a metal sheet of minimum thickness.

2. The lightweight door according to claim 1, wherein a single-part outer skin (9) of the door is permanently connected to the supporting frame (1) and the outer window gutter profile (6).

3. The lightweight door according to claim 1, wherein the supporting frame (1) contributes to forming part of the inside skin (11) of the door.

4. The lightweight door according to claim 1, wherein the supporting frame 1 forms an area-shaped cross stay (1″) which closes the basic U-shape and which is located opposite the door bottom (4).

5. The lightweight door according to claim 3, wherein the supporting frame (1) forms an area-shaped cross stay (1″) which closes the basic U-shape and which is located opposite the door bottom (4).

6. The lightweight door according to claim 1, wherein the connection regions of the various structural members, namely the supporting frame (1), inner door gutter profile (5), lateral impact protection element (7) and window frame (8), spatially coincide so as to form structural frame gussets.

7. The lightweight door according to claim 1, wherein, in more heavily loaded areas, reinforcement and connection sheets (11) are arranged on the supporting frame (1) and permanently connected to said supporting frame (1) by a connection technique of the group press-riveting, bonding, welding.

8. The lightweight door according to claim 6, wherein, in the region of structural frame gussets, reinforcement and connection sheets (11) are arranged on the supporting frame (1) and permanently connected to said supporting frame (1) by a connection technique of the group press-riveting, bonding, welding.

9. A lightweight door for motor vehicles
comprising an essentially U-shaped supporting frame (1) made from light metal or a light metal alloy,
wherein said supporting frame (1) comprises: a hinge support (2) forming one U-limb, a lock support (3) forming the other U-limb and a door bottom (4) forming the U-stay,
with an inner and an outer window gutter profile (5, 6) made from light metal or a light metal alloy, said window gutter profile (5, 6) supplementing the U-shaped supporting frame (1);
wherein if the lightweight door is installed in a motor vehicle body, the window gutter profiles (5, 6) are essentially aligned in longitudinal direction of the vehicle, and the ends of the window gutter profiles (5, 6) are permanently connected to the hinge support (2) and the lock support (3);
comprising a lateral impact protection element (7) arranged in the supporting frame (1), with the ends of said impact protection element (7) being permanently connected to the supporting frame (1), wherein the lateral impact protection element (7) is an extruded profile made from light metal or a light metal alloy; comprising a window frame (8) made from light metal or a light metal alloy, wherein the ends of the window frame (8) in any case are permanently connected to the inner window gutter profile (5);
wherein the supporting frame (1) is made in one piece as a pressed part or a deep-drawn part, from a metal sheet of minimum thickness;
wherein the supporting frame (1) contributes to form part of the inside skin (11) of the door; wherein the supporting frame (1) forms an area-shaped cross stay (1″) which closes the basic U-shape and which is located opposite the door bottom (4); wherein the connection regions of the various structural members, namely the supporting frame (1), inner window gutter profile (5), lateral impact protection element (7) and window frame (8), spatially coincide so as to form structural frame gussets;
wherein, in more heavily loaded areas, reinforcement and connection sheets (11) are arranged on the supporting frame (1) and permanently connected to said supporting frame (1) by a connection technique of the group press-riveting, bonding, welding.

10. The lightweight door according to claim 7, wherein the reinforcement and connection sheets (11) are pressed parts or deep-drawn parts.

11. The lightweight door according to claim 7, wherein the reinforcement and connection sheets (11) in part form hollow chambers (12) with the supporting frame (1), in particular at the hinge support (2).

12. The lightweight door according to claim 1, wherein the inner window gutter profile (5) is a box-section extrusion profile.

13. The lightweight door according to claim 1, wherein the inner window gutter profile (5) is perfectly straight.

14. The lightweight door according to claim 1, wherein the ends of the lateral impact protection element (7) are permanently attached to the supporting frame (1) by means of brackets (14).

15. The lightweight door according to claim 1, wherein upper and lower hinge point strengthening plates (15), made from light metal or a light metal alloy, are permanently attached to the hinge support (2).

16. The lightweight door according to claim 15, wherein the lateral impact protection element (7) on a front side door is arranged so as to slope downward from the hinge support (2) to the lock support (3), or so as to be horizontal, and the free L-limb of the upper hinge point strengthening plate (15) is L-shaped and directly welded together with the end of the lateral impact protection element (7).

17. The lightweight door according to claim 15, wherein on a rear side door the lateral impact protection element (7) is arranged so as to be upward sloping or horizontal from the hinge support (2) to the lock support (3), and wherein the lower hinge point strengthening plate (15) is L-shaped, with its free L-limb being permanently connected to the lateral impact protection element (7).

18. The lightweight door according to claim 1, wherein the ends of the window frame (8) extend beyond the front and rear ends of the inner window gutter profile (5), where they are permanently connected to said window gutter profile (5).

19. The lightweight door according to claim 1, wherein the ends of the window frame (8) abut on top of the front and rear ends of the inner window gutter profile (5), where they are permanently connected to said window gutter profile (5).

20. The lightweight door according to claim 1, wherein the window frame (8), on the side facing the lock support 3, is reinforced by an elongated frame reinforcement part (11d).

21. The lightweight door according to claim 20, wherein the frame reinforcement part (11d) is a pressed part or deep-drawn part made from light metal or a light metal alloy, said frame reinforcement part (lid) being connected to the window frame (8) by way of welding.

22. The lightweight door according to claim 21, wherein the frame reinforcement part (lid) is also welded to the outer window gutter profile (6).

23. The lightweight door according to claim 19, wherein an upper angular section (20) of the window frame (8) is integrated in the frame reinforcement part (lid).

24. The lightweight door according to claim 1, wherein a mirror triangle (22) is formed at the hinge support (2) or at the cross stay (1″) on the top above the inner window gutter profile (5).

25. The lightweight door according to claim 24, wherein a mirror triangle (11c) is provided, designed as a reinforcement and connection sheet (11).

26. The lightweight door according to claim 1, claim 15 or claim 21, wherein the light metal is aluminium and the light metal alloy is an aluminium alloy.

27. The lightweight door according to claim 1, 2, 14, 15, 16, 17, 18 or 19, wherein the permanent connection has been established by welding.

28. The lightweight door according to claim 9, wherein the reinforcement and connection sheets (11) are pressed parts or deep-drawn parts.

29. The lightweight door according to claim 28, wherein the reinforcement and connections sheets (11) in part form hollow chambers (12) with the supporting frame (1), in particular at the hinge support (2).
